(19) United States
(12) Patent Application Publication
(10) Pub. No.: US 2026/0146704 A1
(43) Pub. Date: May 28, 2026

(54) MULTI-COMPONENT COMPATIBLE SUPPORT MEMBER

(71) Applicant: Miro Industries, Inc., Heber City, UT (US)

(72) Inventors: Samuel Richard Robins, Heber City, UT (US); Jarrett Welch, Heber City, UT (US)

(21) Appl. No.: 19/402,863

(22) Filed: Nov. 26, 2025

Related U.S. Application Data
(60) Provisional application No. 63/726,120, filed on Nov. 27, 2024.

(51) Int. Cl. F16M 11/22; F16M 11/04

(52) U.S. Cl. CPC F16M 11/22; F16M 11/04

(57) ABSTRACT

In one form, a device includes a base portion, a raised mounting portion extending from the base portion, and a number of weight distributing members extending from the raised mounting portion to the base portion and configured to distribute weight from the raised mounting portion to the base portion. The raised mounting portion includes a number of different mounting openings providing a plurality of mounting patterns configured to facilitate mounting of a number of different components each having a unique mounting pattern corresponding to one of the mounting patterns provided by the number of different mounting openings.

### FIELD

The present disclosure generally relates to a support member. More particularly, but not exclusively, the present disclosure relates to a support member to which a variety of other components may be coupled, and which may be used for the support of objects on a rooftop or similar setting.

### BACKGROUND

Unless otherwise indicated herein, the materials described herein are not prior art to the claims in the present application and are not admitted to be prior art by inclusion in this section.

Various objects, including HVAC ductwork, refrigeration lines, electrical conduit and/or modular walkways, amongst others, may be positioned on the rooftop of a structure. Membrane materials may be used on the rooftop, and these materials may be damaged by the objects positioned on the rooftop. As such, direct positioning or fastening of these objects to the membrane may typically be avoided. Support members may be used to space the objects from the rooftop and the objects may be secured to the support members with one or more coupling components. Generally speaking, a support member designed to prevent rooftop damage and facilitate easy coupling of objects thereto, and which may provide adjustability and ease of use, may be desired.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In one embodiment, a device includes a base portion and a raised mounting portion extending from the base portion. A number of weight distributing members extend from the raised mounting portion to the base portion and are configured to distribute weight from the raised mounting portion to the base portion. The raised mounting portion includes a number of different mounting openings providing a plurality of mounting patterns configured to facilitate mounting of a number of different components each having a unique mounting pattern corresponding to one of the mounting patterns provided by the number of different mounting openings.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a support member;

FIG. 2 is a top, plan view of the support member of FIG. 1;

FIG. 3 is an alternative perspective view of the support member of FIG. 1;

FIG. 4 is a bottom view of the support member of FIG. 1; and

FIG. 5 is a side view of the support member of FIG. 1.

### DETAILED DESCRIPTION

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

The present disclosure generally relates to component support members. More particularly, but not exclusively, the present disclosure relates to support members which may be used for the support of components on a rooftop or similar setting. It will be appreciated that embodiments disclosed herein may be employed in a variety of fields and/or operating environments where the functionality disclosed herein may be useful. Accordingly, the scope of the invention should not be construed to be limited to the exemplary implementations and operating environments disclosed herein.

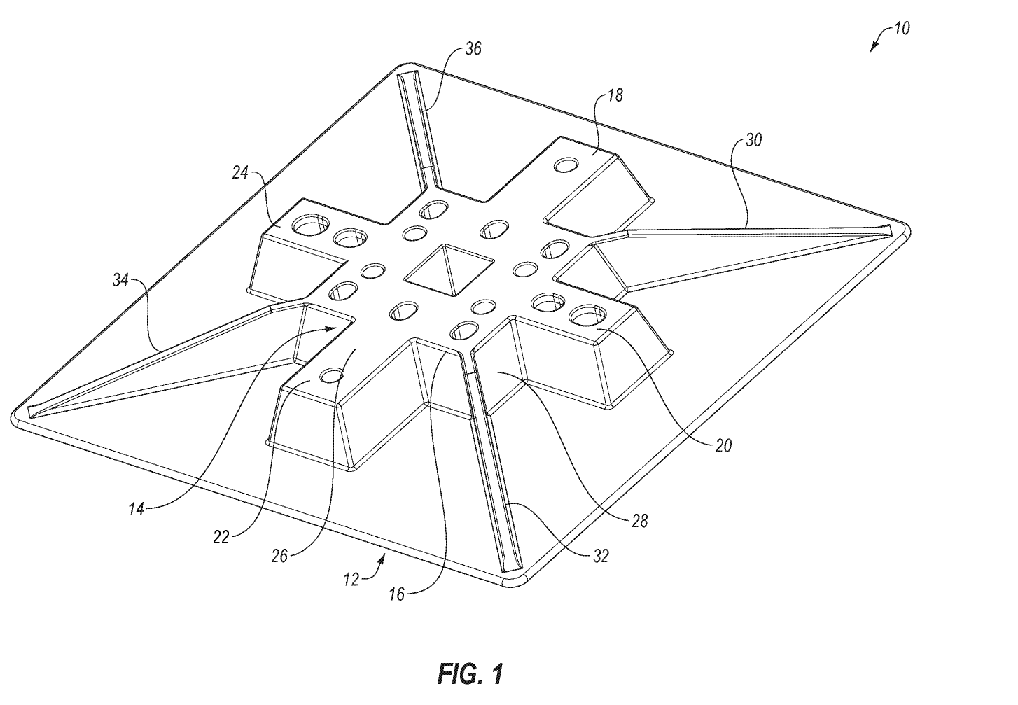

With general reference to FIGS. 1-5 for example, there is illustrated one embodiment of a support member 10. The support member 10 includes a base portion 12 having a polygonal shape which in the illustrated form is a square. However, other shapes and configurations for the base portion 12 are possible and contemplated. The support member 10 further includes a raised mounting portion 14 extending from the base portion 12. The mounting portion 14 generally has a cross-shaped configuration which is defined by a square central portion 16 from which arms 18, 20, 22 and 24 extend. Variations in the shape and configuration of the mounting portion 14 are possible and contemplated. In the illustrated configuration, the mounting portion 14 is smaller than the base portion 12 and is positioned relative to the base portion 12 such that the mounting portion 14 is surrounded by the base portion 12. However, alternative configurations are envisioned. The mounting portion 14 further includes an upper surface which provides a mounting platform 26 on which a coupling component (not illustrated) may be positioned and coupled to the support member 10, further details of which will be provided below. The coupling component may be configured to facilitate coupling between the support member 10 and one or more objects such as HVAC ductwork, refrigeration lines, electric conduit and/or modular walkways, just to provide a few examples.

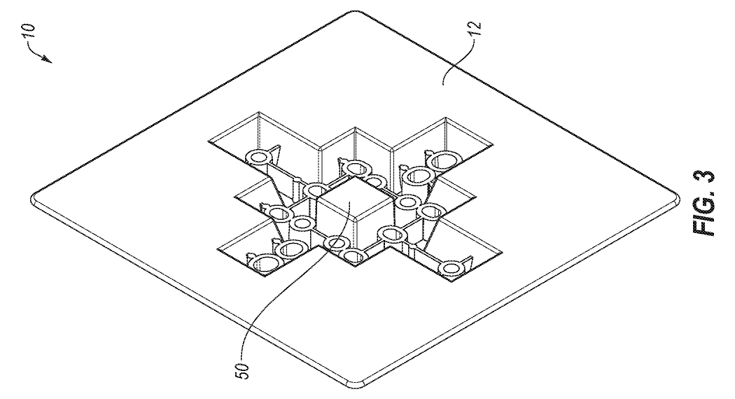

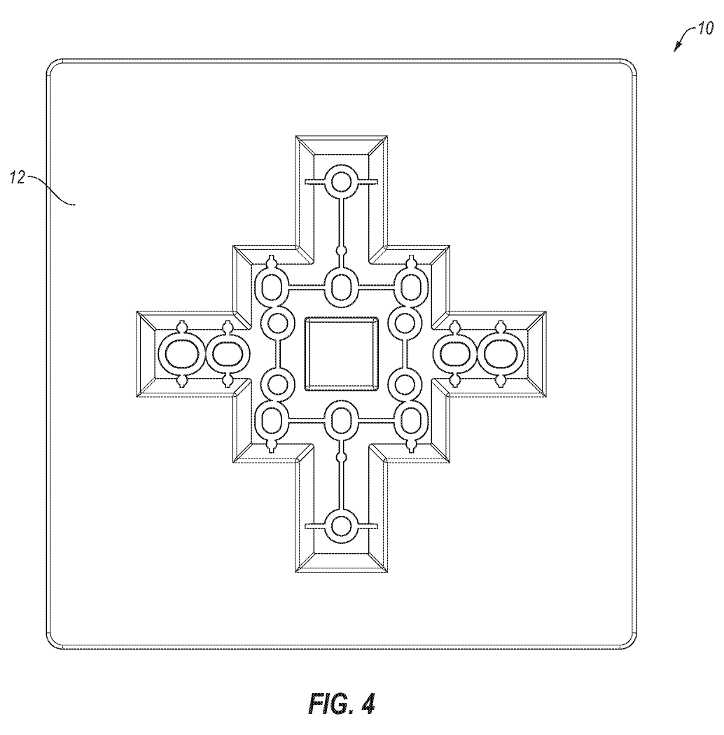

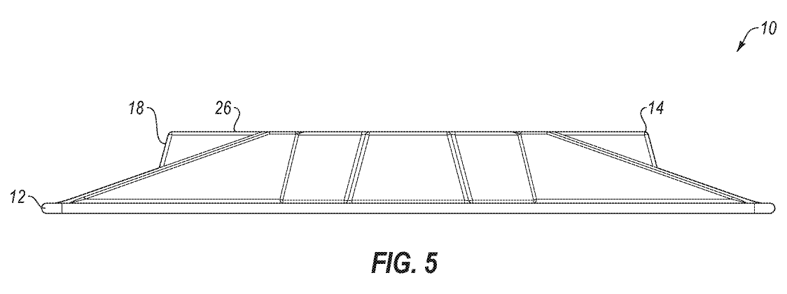

A sidewall 28 extends from the base portion 12 to the mounting platform 26 in an arrangement which spaces the mounting platform 26 from the base portion 12. In the illustrated form, the sidewall 28 extends around the mounting platform 26, although forms in which the sidewall 28 is discontinuous and only extends between portions of the base portion 12 and the mounting platform 26 are possible. As best seen in FIG. 5 for example, the sidewall 28 extends obliquely to the base portion 12 and the mounting platform 26, although forms in which the sidewall 28 extends orthogonally to the base portion 12 and the mounting platform 26 are also envisioned. With reference to FIGS. 3 and 4, it can be seen that in the illustrated form the support member 10 generally includes an open or hollow configuration below the mounting platform 26.

The support member 10 also includes weight distributing members 30, 32, 34 and 36 which extend from the mounting portion 14 to the base portion 12. The weight distributing members 30, 32, 34 and 36 are generally configured to distribute weight from the mounting portion 14 to the base portion 12. In some aspects, this configuration may facilitate even, or generally even, distribution of the weight of any coupling component positioned on the mounting portion 14, and any object(s) coupled to the coupling component, across the base portion 12 to minimize impact to an underlying surface on which the support member 10 is positioned during use. Similarly, the surface area of the base portion 12 may be designed or selected to increase the contact area between the support member 10 and a surface on which it is positioned, such as a rooftop membrane material, in order to minimize impact or damage to the surface by the support member 10. In the illustrated form, each of the weight distributing members 30, 32, 34 and 36 extends from a respective corner of the square central portion 16 toward a respective corner of the base portion 12. In other forms, it is possible for the support member 10 to include an additional number of weight distributing members, and/or for the weight distributing members to be positioned at locations alternative to those illustrated. The weight distributing members 30, 32, 34 and 36 each generally include an inclined upper surface that extends from the base portion 12 to the upper surface or mounting platform 26 of the raised mounting portion 14.

Turning now more specifically to the raised mounting portion 14, it includes a number of different mounting openings formed on the mounting platform 26 which provide a plurality of mounting patterns configured to facilitate mounting of a number of different coupling components each having a unique mounting pattern corresponding to at least one of the mounting patterns provided by the number of different mounting openings on the mounting platform 26. In this configuration, the support member 10 provides flexibility to be used with a wide variety of different coupling components.

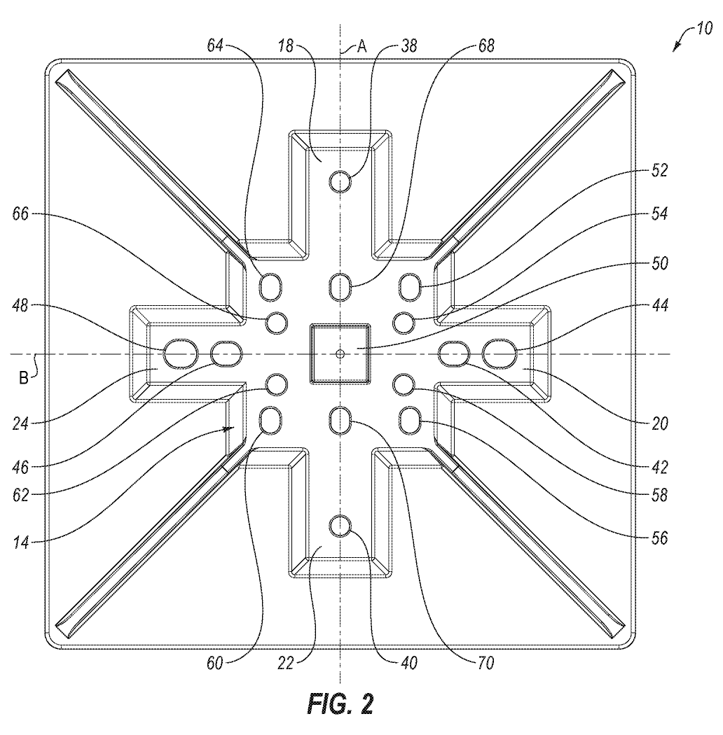

As best seen in FIG. 2 for example, the mounting platform 26 includes a circular opening 38 on the arm 18 and a circular opening 40 on the arm 22. The mounting platform 26 also includes an oval or oblong opening 42 on the arm 20 and an oval or oblong opening 44 on the arm 20 where the opening 42 is smaller than the opening 44, and an oval or oblong opening 46 on the arm 22 and an oval or oblong opening 48 on the arm 22 where the opening 46 is smaller than the opening 48. The mounting platform 26 also includes a central receptable 50 on the square central portion 16, which in the illustrated form has a square configuration, an oval or oblong opening 52 positioned adjacent to a circular opening 54 between the arm 18 and the arm 20, an oval or oblong opening 56 positioned adjacent to a circular opening 58 between the arm 20 and the arm 22, an oval or oblong opening 60 positioned adjacent to a circular opening 62 between the arm 22 and the arm 24, and an oval or oblong opening 64 positioned adjacent to a circular opening 66 between the arm 24 and the arm 18. In addition, on the square central portion 16 the mounting platform 26 includes an oval or oblong opening 68 adjacent to the arm 18 and an oval or oblong opening 70 adjacent to the arm 22. As illustrated in FIG. 2 for example, the various mounting openings on the mounting platform 26 are symmetrically positioned relative to the axis A or the axis B. In addition, the mounting openings may have an open or a closed configuration. For example, as shown in FIG. 3, the opening 52 has a closed configuration, meaning that a surface closes the bottom thereof. Other openings illustrated in FIG. 3 have open configurations, meaning that there is no surface that closes a bottom thereof.

As suggested above, the support member 10 may be engaged or coupled with a number of different coupling components configured to provide engagement or coupling between an object and support member 10. A few non-limiting examples of different coupling components include struts, channels and clamps, although other variations are envisioned. The objects which may be supported by the support member 10 include HVAC ductwork, refrigeration lines, electric conduit, plumbing lines and/or modular walkways.

The support members described herein may be made from a variety of different materials. In some aspects, the support members may be made from a polymer or plastic material. However, other variations are possible and contemplated.

In one embodiment, a device includes a base portion; a raised mounting portion extending from the base portion; and a number of weight distributing members extending from the raised mounting portion to the base portion and configured to distribute weight from the raised mounting portion to the base portion. The raised mounting portion includes a number of different mounting openings providing a plurality of mounting patterns configured to facilitate mounting of a number of different components each having a unique mounting pattern corresponding to one of the mounting patterns provided by the number of different mounting openings.

In one form, the raised mounting portion includes a central receptacle and the number of different mounting openings are positioned around the central receptacle.

In one aspect of this form, the central receptacle includes a closed configuration.

In a further aspect of this form, one or more of the number of different mounting openings includes an open configuration.

In another form, one or more of the number of different mounting openings includes a circular configuration.

In one aspect of this form, one or more of the number of different mounting openings includes an oblong configuration.

In another form, the raised mounting portion includes a sloped sidewall extending from the base portion.

In one aspect of this form, the raised mounting portion includes a mounting surface spaced above the base portion by the sloped sidewall.

In another form, the raised mounting portion includes a cross-shape configuration.

In one aspect of this form, the raised mounting portion includes a number of arms defining the cross-shape configuration and at least one of the number of weight distributing members is positioned between a first arm and a second arm of the number of arms.

In still another form, a portion of the base portion extends around the raised mounting portion.

In one aspect of this form, each of the number of weight distributing members is configured to distribute weight from the raised mounting portion to the portion of the base portion extending around the raised mounting portion.

In another form, each of the number of weight distributing members tapers from the raised mounting portion to the base portion.

In yet another form, the number of different mounting openings are symmetrically positioned about a center point of the raised mounting portion.

In still another form, one or more of the different mounting openings vary based on at least one of size and shape.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device, comprising:
a base portion;
a raised mounting portion extending from the base portion; and
a number of weight distributing members extending from the raised mounting portion to the base portion and configured to distribute weight from the raised mounting portion to the base portion;
wherein the raised mounting portion includes a number of different mounting openings providing a plurality of mounting patterns configured to facilitate mounting of a number of different components each having a unique mounting pattern corresponding to one of the mounting patterns provided by the number of different mounting openings.

2. The device of claim 1, wherein the raised mounting portion includes a central receptacle and the number of different mounting openings are positioned around the central receptacle.

3. The device of claim 2, wherein the central receptacle includes a closed configuration.

4. The device of claim 3, wherein one or more of the number of different mounting openings includes an open configuration.

5. The device of claim 1, wherein one or more of the number of different mounting openings includes a circular configuration.

6. The device of claim 5, wherein one or more of the number of different mounting openings includes an oblong configuration.

7. The device of claim 1, wherein the raised mounting portion includes a sloped sidewall extending from the base portion.

8. The device of claim 7, wherein the raised mounting portion includes a mounting surface spaced above the base portion by the sloped sidewall.

9. The device of claim 1, wherein the raised mounting portion includes a cross-shape configuration.

10. The device of claim 9, wherein the raised mounting portion includes a number of arms defining the cross-shape configuration and at least one of the number of weight distributing members is positioned between a first arm and a second arm of the number of arms.

11. The device of claim 1, wherein a portion of the base portion extends around the raised mounting portion.

12. The device of claim 11, wherein each of the number of weight distributing members is configured to distribute weight from the raised mounting portion to the portion of the base portion extending around the raised mounting portion.

13. The device of claim 1, wherein each of the number of weight distributing members tapers from the raised mounting portion to the base portion.

14. The device of claim 1, wherein the number of different mounting openings are symmetrically positioned about a center point of the raised mounting portion.

15. The device of claim 1, where one or more of the different mounting openings vary based on at least one of size and shape.
